(19) United States
(12) Patent Application Publication
(10) Pub. No.: US 2005/0107131 A1
(43) Pub. Date: May 19, 2005

(54) Wireless apparatus with detachable element

(76) Inventor: Igor Abramov, Oceanside, CA (US)

Correspondence Address: IGOR ABRAMOV;SUITE 2B-602, 3529 CANNON RD, OCEANSIDE, CA, 92056, US

(21) Appl. No.: 10/986,740

(22) Filed: Nov. 12, 2004

Related U.S. Application Data
(60) Provisional application No. 60/519,998, filed on Nov. 15, 2003.

(51) Int. Cl. H04Q 7/20

(52) U.S. Cl. 455/569.1; 455/575.6

(57) ABSTRACT

A detachable element such as a headset (20) which stowable in a mobile electronic device (e.g., cellular phone (10)) is described. In one embodiment, while in the phone (10) the headset (20) serves as the phone (20) speaker and microphone. Upon detachment from the phone (10) the headset (20) spontaneously changes its shape to facilitate user convenience. A wireless version of the handset (20a) automatically enters a stand-alone operational mode when detached from the phone (10). Separate and distinct embodiments of the headset (20) and (50) exist for a single piece phone (10) and a flip-type phone (40) respectfully.

### PRIORITY

This application claims priority to U.S. Provisional Application Ser. No. 60/519,998 filed Nov. 15, 2003 entitled “Wireless Apparatus With Detachable Headset”, incorporated herein by reference in its entirety.

### BACKGROUND

1. Field of Invention

This invention relates to communications devices in general and in one exemplary aspect to headsets used with, e.g., cellular and cordless phones and radios.

2. Prior Art

It is desirable to enable a hands-free operation of such wireless communication devices as cellular and cordless phones and personal radios.

For instance, while driving a vehicle a hands-free phone operation not only provides convenience but also contributes to driver safety. One of the methods to achieve hands-free operation is to operate a phone in a speaker mode.

Unfortunately, in noisy environments such as a moving vehicle, when speaker mode is used the sound quality is significantly degraded, as both a speaker and a microphone are normally positioned at a relatively long distances from the user and are subject to interference and feedback. Even when a separate microphone is being used which can be positioned closer to the user, the speaker part of the system is still positioned relatively distant which creates privacy issues and still is susceptible to feedback.

Another solution for hands-free operation is to use a separate headset which is worn by the user and is either connected to a phone by a cable or communicates with it wirelessly.

While it provides a higher quality two-way audio communication, a separate headset needs to be stored somewhere when not in use, which tends to limit its utility.

A more attractive solution is to provide a detachable headset on the phone itself. Such headset is stored on the phone and is operational both while attached to the phone or detached from it. An additional economic advantage can be realized if a headset replaces the phone speaker and a microphone.

The challenge to create such a system arises from a set of mutually dependent and sometimes conflicting requirements for the headset implementation. One requirement is for the headset to be securely attached to and quickly and easily detached from a phone. Another requirement is for a headset to be ergonomic while in stand-alone use, to minimize user fatigue and discomfort while maintaining a reasonable level of esthetic presentation. Yet another requirement is to provide high quality two-way audio communications.

It is also advantageous in case of a wireless headset to be able to re-charge it's power storage device from the phone power source, or at least to disable or minimize the power draw from the headset internal power source while the headset is operated while on the phone.

Attempts have been made to provide storage of a headset on the phone and to meet some of the requirements above. For example, U.S. Pat. No. 5,590,417 to Rydbeck describes two embodiments of a wireless headset stored on the phone. In one embodiment the headset is attached to the side of the phone while in another embodiment the headset is attached to the front of the phone.

The limitations of these arrangements are that when the headset is attached to the side of the phone, a user has to hold the phone sideways in order to use the headset in its in-the-phone mode, and when a headset is attached to the front of the phone, it interferes with the display and the keypad operation.

U.S. Pat. No. 6,256,386 to Phillips describes a corded headset which is stored inside an enclosure. In addition to the presence of the cord, which is not desirable from several standpoints, in order to use the headset in the stand-alone mode a user has to manually flip the earpiece part of the headset, further contributing to its inconvenience in use. The earpiece fits inside of user's ear and the microphone portion is suspended by the earpiece. Depending on the actual size and weight of this headset assembly, user comfort may be jeopardized. Moreover, the present corded design is not likely to be successfully converted to a wireless handset, due to the wireless headset necessarily greater weight and size and the fact that the device is proposed to simply hang from the ear canal of the user. This further limits potential usage of this device.

### SUMMARY OF THE INVENTION

In accordance with the present invention, improved apparatus and methods for wireless communication are provided.

In a first aspect of the invention, improved communications apparatus for use with a wireless communication device is disclosed. In one embodiment, the apparatus comprises: a communications element adapted for removable storage within the wireless communication device, the element being configured for contactless communication with the wireless communication device; wherein the communications element is further adapted to substantially assume a predetermined shape upon removal from the wireless communication device. The communication element may comprise, e.g., a headset which is removable from a cellular telephone or other mobile electronic device.

In a second aspect of the invention, an improved communications apparatus is disclosed. In one embodiment, the apparatus comprises: a first wireless interface adapted to transmit and receive first radio frequency signals to a remote entity; a body element having at least one recess formed therein; a power source disposed substantially within the body element; a detachable headset element adapted to be received at least partly within the recess; a second wireless interface adapted to transfer communication signals between the body element and the headset; a contactless interface between the body element and the headset, the contactless interface adapted to transfer power between the power source and the headset when the headset is substantially received within the recess; wherein when the headset element is received within the at least one recess, the headset element substantially assumes a first shape, and when the headset element is removed from the recess, assumes a second, predetermined shape different from the first shape, the second predetermined shape being substantially adapted for fitting over at least a portion of the human ear.

In a third aspect of the invention, improved communications apparatus for use with a wireless communication device is disclosed. In one embodiment, the apparatus comprises: a communications element adapted for removable storage at least partly within the wireless communication device, the element being configured for contactless communication with the wireless communication device; wherein the communications element is further adapted to substantially assume at least one of plurality of colors upon contact with a user.

In a fourth aspect of the invention, a method of operating a headset being disposed substantially within a communications device is disclosed. In one embodiment, the disposed headset has a first shape, and the method comprises: removing the headset from within the device, the act of removing causing the headset to assume a second shape; disposing the headset onto at least a portion of a user's head; and wirelessly communicating with the device via the headset.

In a fifth aspect of the invention, an improved wireless communications system comprising a detachable headset and an electronic device is disclosed. In one embodiment, the headset is removably stored on the device, the headset adapted for communication with the device in at least one of two modes: a first mode such that when stored on the device, the headset communicates with the device via a first wireless communications interface; and a second mode such that when removed from the device, the headset communicates with the device via a second wireless communications interface.

### BRIEF DESCRIPTION OF THE DRAWINGS

FIGS. 1 and 1a show prior art cellular phones with detachable headsets

FIG. 2 shows a perspective of a one-piece cellular phone with a headset stowed in.

FIG. 3 shows a headset shape change from a stowed mode to stand alone mode.

FIGS. 3a, 3b, 3c, 3d show variations of the headset having articulating earpiece and microphone

FIG. 4 shows a cross section taken along line 4-4 on FIG. 2

FIG. 5 shows positioning of the headset when worn by user

FIG. 6 shows a one-piece cellular phone with the headset detached

FIG. 7 shows a flip-type cellular phone with the headset detached

FIGS. 8, 8a, 8b show hinged headset used with flip-type cellular phones.

FIG. 9 illustrates storage of the hinged headset into a closed flip-type cellular phone

FIG. 10 is an electrical block diagram of the headset and related circuitry in the cellular phone.

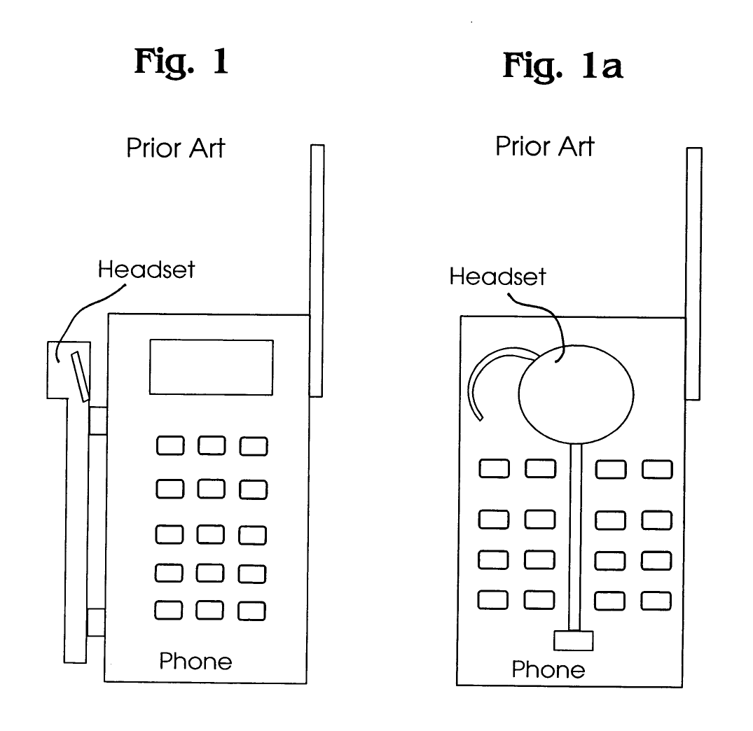

### DESCRIPTION OF THE PREFERRED EMBODIMENT

As used herein, the terms “wireless” and “contactless” are used to refer to apparatus or methods which operate without direct electrical or other physical contact. Examples of wireless/contactless apparatus include, without limitation, radio frequency (RF) interfaces, optical interfaces, infrared interfaces, inductive interfaces, and capacitive interfaces.

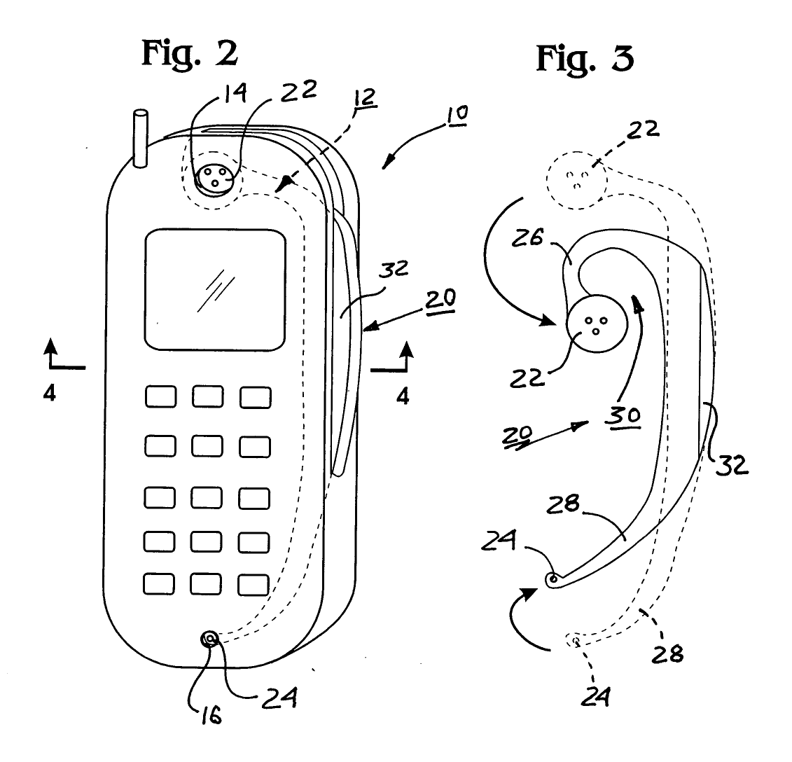

The preferred embodiment of the present invention is illustrated on FIG. 2. A cellular phone 10 contains cavity 12 which receives headset 20. The face of the phone contains apertures 14 and 16 which are aligned with headset earpiece 22 and microphone 24 respectfully. The shapes and placement of these apertures are selected to maximize sound transmission to the microphone 24 and from the earpiece 22. Apertures 14 and 16 may be of an open type or can incorporate protective grilles or meshes. The cross section of the cavity 12 essentially matches the cross section shape of the headset.

An essentially longitudinal slot 18 extending through a portion of cavity 12 is provided for insertion of the headset 20 and to enable the grip 32 to be exposed. It should be noted that the width of the slot 18 is not uniform throughout its length but is made to accommodate the insertion and retention of headset 20.

For it to be used outside the phone in a stand-alone mode, headset 20 is removed from the cavity 18 by the user's grasping grip 32 on the body of the handset and pulling upward and away from the phone body.

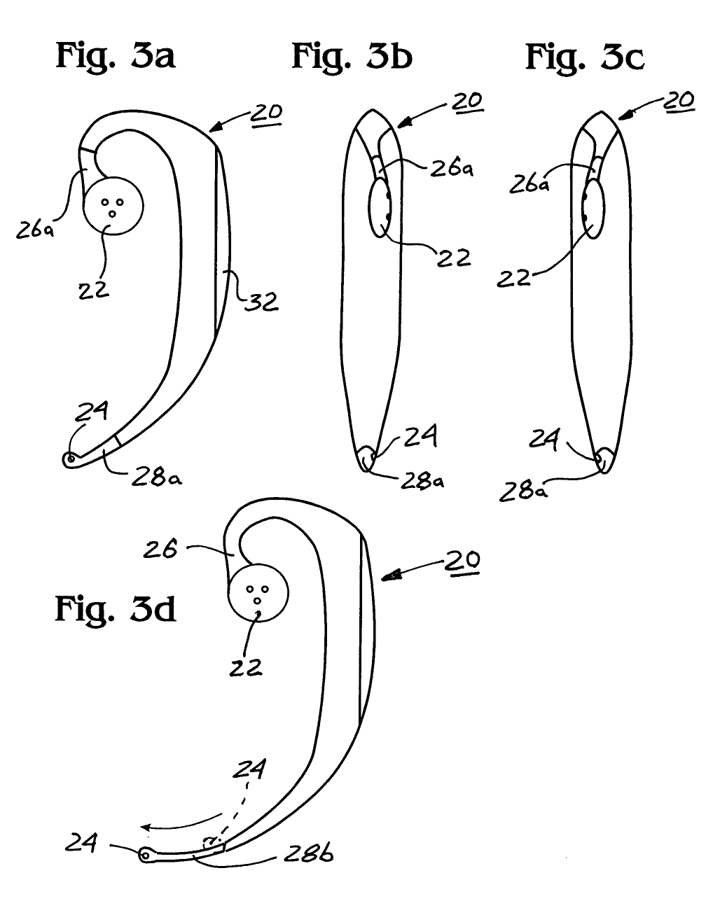

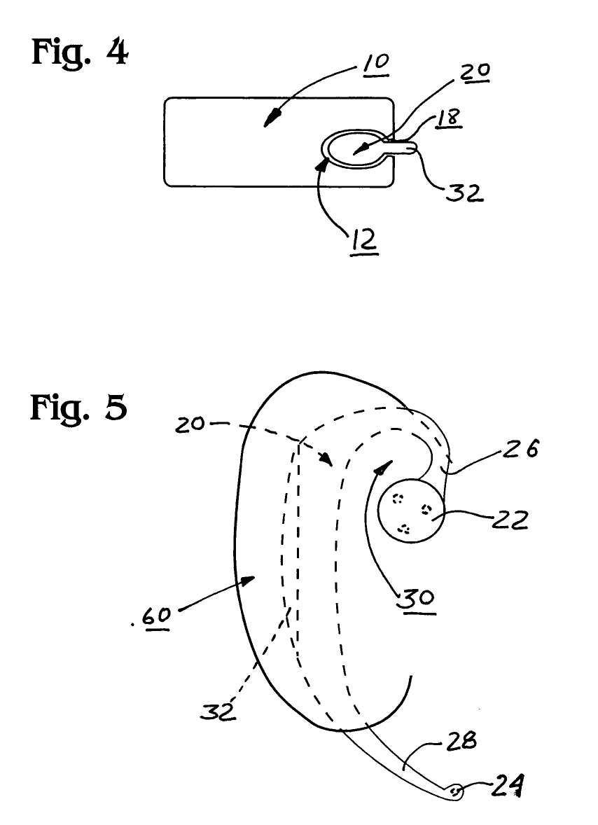

As shown of FIG. 3 upon exit from the cavity 12, the headset 20 assumes a new shape denoted in the figure by solid lines. Due to the bending of the earpiece stalk 26 the earpiece 22 descends downward and toward the main body of the headset thus creating an open loop 30. Simultaneously, through the upward bending motion of the microphone stalk 28 the microphone 24 assumes its position essentially below the new position of the earpiece 22.

The resulting shape of the headset is conducive to a comfortable wear of the headset as illustrated on FIG. 5 where the headset 20 is draped over and behind a user's ear 60. In this position the earpiece 22 is positioned at the entrance of the auditory canal while the microphone 24 is projected below the earlobe and toward user's mouth. Thus, not only the respective positions of the earpiece 22 and microphone 24 are conducive to superior two-way sound quality, but the whole headset is largely concealed behind a user's ear where it has a less chance of causing discomfort to the user, interfere with user's activities or be too conspicuous.

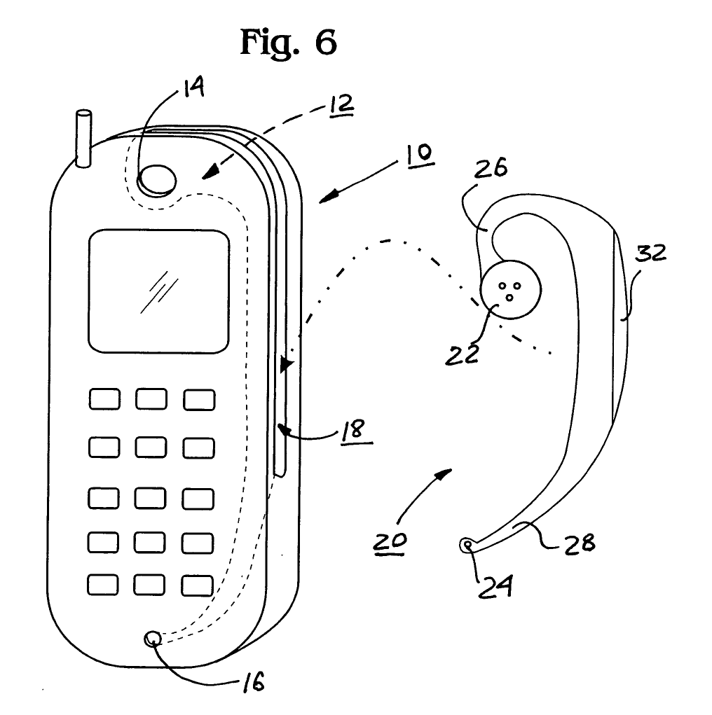

To return the headset 20 to the phone 10 as shown on FIG. 6 a user holds the headset by the grip 32 and slides it microphone 24 end first into the cavity 12. The microphone stalk 28 resiliently bends and follows the shape of the cavity 12. The microphone 24 is then positioned behind aperture 16 in the phone 10. The earpiece stalk 26 then is then urged to unbend and the earpiece takes its place behind the aperture 14 in the phone 10.

The headset operates electrically in two modes. In in-the-phone mode the earpiece 22 and the microphone 24 operate as a speaker and a microphone of the phone 10. In stand-alone mode when the headset is removed from the phone, it communicates with the phone but the sound is emitted and sensed only by the headset, not by the phone.

FIG. 10 shows an electrical systems block diagram pertaining to co-operation of the headset and the phone. The diagram pertains to a wireless type of headset denoted 20a, since for a wired headset the operation is greatly simplified because the headset can be considered as mere remote speaker and a microphone still permanently attached to the phone.

For the in-phone operation, the following steps are taken to place the system into the in-the-phone operational mode: the headset presence is detected, the headset power is switched to come from the phone, unless the handset's energy level is sufficient to power it, or the energy level of the phone is determined not to be sufficient to support the headset operation in addition to its own circuitry. The wireless transceivers both in the phone and in the headset are then switched off, unless the system is designed to operate via wireless transceivers in close proximity. The audio channel in the headset is switched from the transceiver to the local contact-less coupling element through which the signals are conveyed to the phone.

Referring again to FIG. 10, the control unit 200 of the phone 10 periodically briefly turns power oscillator 160 on which through the coil 162 emits an electromagnetic pulse. The effective impedance of the coil 162 is simultaneously monitored by phone headset detector 170. When the wireless headset 20a is inserted in phone 10, it's presence is detected by the phone headset detector 170 as a change in effective impedance of coil 162 due to its loading by the headset coil 142.

Alternatively, the headset detector 170 can be a magnetically activated reed switch, an electromechanical switch or an opto-electronic switch, all these types being familiar to those skilled in the art.

When the headset is thusly detected by the headset detector 170 the phone control unit 200 is notified and initializes energy transfer operation from phone energy storage element 200 by fully turning on the power oscillator 160 and transferring energy through the coil 162 to the headset coil 142. The electromagnetic energy received by coil 142 is converted by headset power converter 140 for the use by the rest of the headset circuitry.

The phone control unit 200 then shuts down its secondary wireless transceiver used to communicate with the headset and activates its audio processor 180.

The presence of power input from the phone is detected by headset power detector 150 which notifies headset control unit 120. The control unit 120 determines the energy level of headset energy storage element 102, and if it's below a pre-determined level initiates its charging.

Simultaneously, control unit 120 switches the headset wireless transceiver 104 off and activates audio transfer switches 108, while activating the audio processor 110 which communicates with phone audio processor 180 via a contact-less coupling coils 112 and 182.

When the headset is removed from the phone the phone headset detector 170 notifies control unit 200 which then initiates steps corresponding to headset stand alone mode. The power oscillator 160 is placed in low energy headset seeking mode and made to emit intermittent low power short pulses, the audio processor 180 is shut off and the wireless secondary transceiver 220 is turned on.

Upon headset's 20a removal from the phone 10 the headset power converter 140 no longer detects energy emitted by the phone power oscillator 160 and notifies control unit 120 which places the headset 20a in the stand-alone mode.

The control unit 120 switches power to the energy storage element 102, turns on headset transceiver 104, shuts off audio processor 110 and redirects audio signals to the earpiece 22 and from microphone 24 via their respective switches 108 and amplifiers 106 to headset transceiver 104.

It should be noted that although the contact-less coupling between the wireless headset 20a and the phone 10 was shown implemented with electromagnetic coils 142, 162, 112, and 182, other means are possible as well, such as with opposing plate capacitive coupling, or opto-electronic, these methods being familiar to persons skilled in the art.

The absence of exposed electrical contacts enables a completely sealed construction for the wireless headset 20a, since other exposed components, namely the earpiece 22 and the microphone 24 can be made sealed as is known in the art. Such a construction offers many advantages to a consumer product such as a headset, and especially one in prolonged contact with human skin.

### Additional Embodiments

In the foregoing description like components are labeled with like numerals.

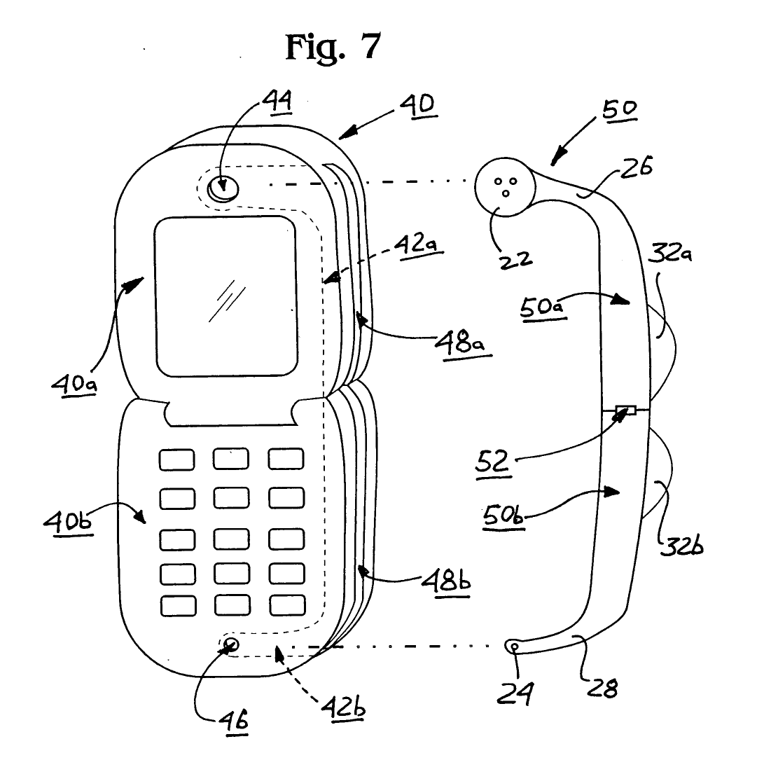

Referring to FIG. 7, a flip-type cellular phone 40 consists of two hinged halves 40a and 40b, each having cavities 42a and 42b for storing the headset 50.

The headset 50 contains earpiece 22 and microphone 24, each located on the end of their respective stalks, denoted by numerals 26 and 28. The body of the headset 50 is provided with a hinge assembly 52 located essentially in the middle of the headset's body and connecting upper and lower parts 50a and 50b of the headset. The headset 50 is further provided with two grips 32a and 32b located on upper and lower parts 50a and 50b respectively.

When the phone 40 is open or unfolded, the headset 50 is inserted in the open state straight in into the cavities 42a and 42b through their respective side slots 48a and 48b. Once in the cavity, the headset earpiece 22 is positioned behind aperture 44 in the upper phone half 40a, while the headset microphone is positioned behind aperture 46 in the lower phone half 40b. The headset 50 is held in the cavities 42a and 42b essentially by a friction fit. Alternatively, a plurality of detents can be supplied in the cavities to capture the headset.

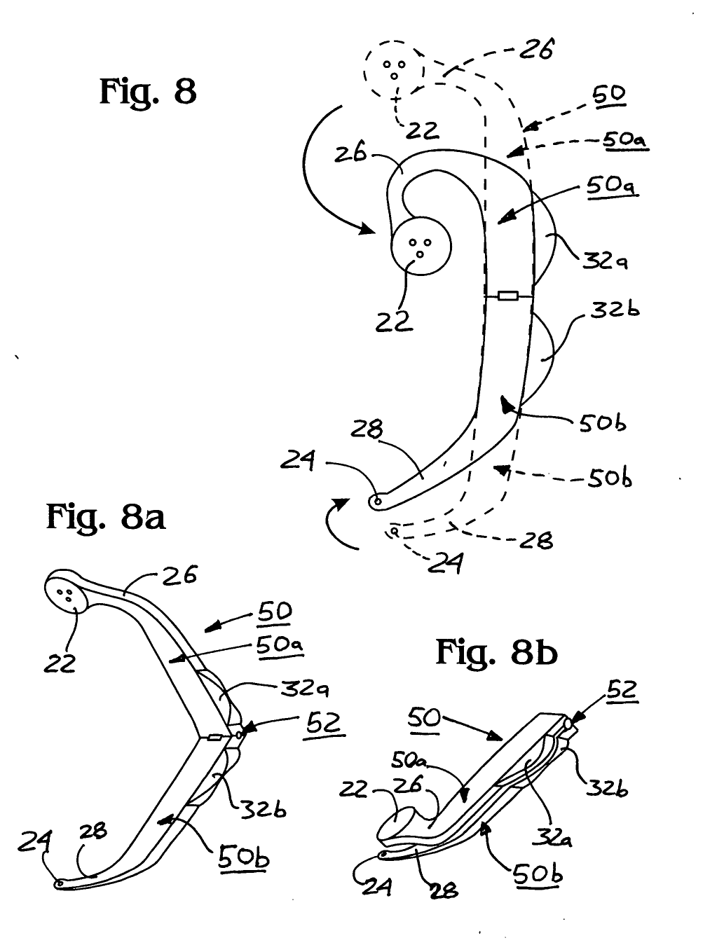

Referring to FIG. 8, upon its removal from the phone the headset 50 spontaneously assumes its stand-alone shape denoted by solid lines. The resulting overall shape is similar to the shape of the non-hinged headset 20, with the difference in additional spontaneous unfolding of the hinged version at the hinge assembly 52. To enable this unfolding the hinge assembly 52 contains a spring or resilient element.

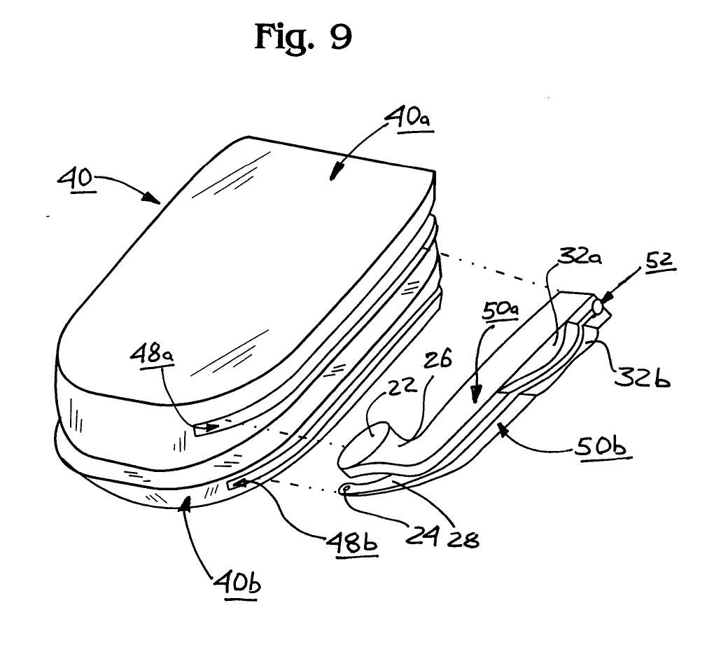

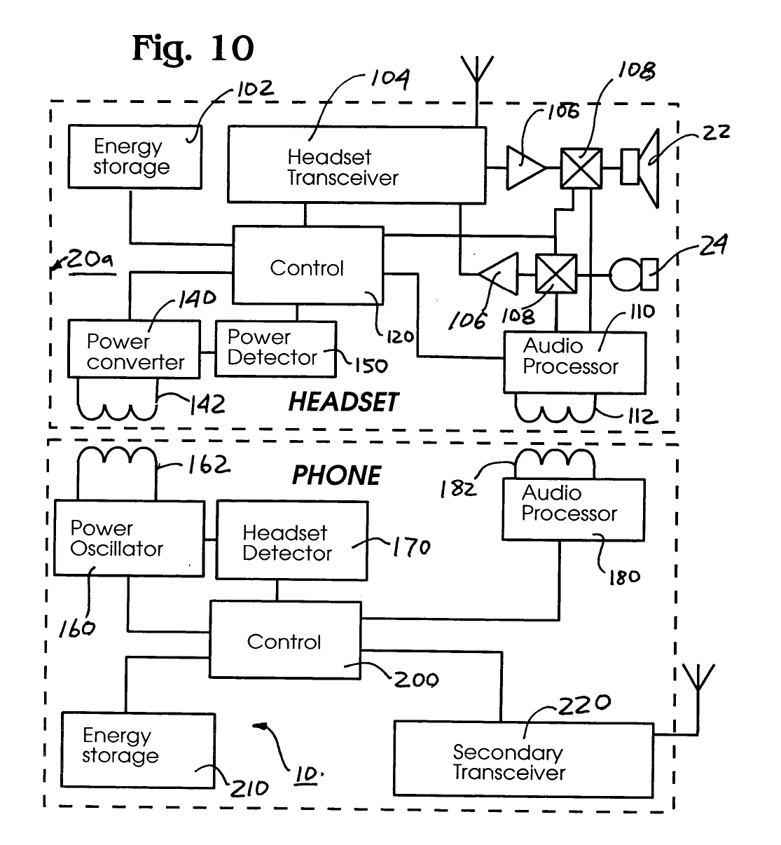

FIG. 9 shows insertion of headset 50 into phone 40 while the latter is closed. To accomplish this the headset body halves 50a and 50b are folded toward each other at the hinge assembly 52 as shown on FIGS. 8a and 8b. By grasping the headset 50 simultaneously by the grips 32a and 32b, a user would insert the headset 50 into corresponding cavities 42a and 42b through corresponding slots 48a and 48b in the respective phone upper half 40a and lower half 40b.

The headset can be extracted from the phone by grasping the grips 32a and 32b and pulling outwards. Upon exit from the phone the headset 50 spontaneously unfolds at the hinge assembly 52 and simultaneously assumes the stand-alone shape due to resilient bending of the respective earpiece and microphone stalks 26 and 28.

The electrical operation of this headset and the phone is similar to the one described above.

FIGS. 3a-3d show a variation of the headset 20. The headset variation on

FIGS. 3a-3c contains pivotable earpiece stalk 26a and pivotable microphone stalk 28a. This feature enables a user to select which ear to use by rotating the respective stalks and thus aiming the earpiece 22 and microphone 24 to an opposite side of the headset 20, as shown on FIGS. 3b and 3c.

FIG. 3d shows a headset 20 with a telescoping microphone stalk 28b which facilitates voice quality in overly noisy environments.

To enable resilient spontaneous folding of the headset for the stand-alone operation the headset construction may contain a flexible core member onto which electronic components are mounted, the whole assembly further enclosed by preferably an elastomeric skin. As was noted earlier, the headset can be completely sealed against the elements, including those of biological nature. Flexible electronic circuits are well known in the art.

The unfolding action of the flexible core member can be effected by making this member out of a memory-shape alloy, such as Nitinol™, which can be activated by exposure to the user's body heat when the headset is worn. Alternatively, an electric current can be passed through the core member to heat it and so cause it to bend in an advantageous way. The memory shape effect of Nitinol can be tailored to be activated at a particular temperature by adjusting the composition of this alloy and its preparation. This is known in the art as well.

Also, thanks to the additional superplasticity property of Nitinol alloys the headset core member made out of this material can be pre-folded into a shape suitable for stand-alone operation, and then unfolded for insertion into the phone. Upon extraction from the phone the headset will regain its previous shape, with exceptional repeatability and metal fatigue endurance. This property of Nitinol alloys is successfully exploited in eyeglass frames and cellular phone antennae.

Alternatively, the headset can be made entirely out of an elastomer polymer, with its circuitry embedded into it.

Bimetallic and piezoelectric elements can be also incorporated into the headset to controllably alter its shape. Such elements change their geometries in response to temperature and electrical voltage, respectively.

Finally, the outward color appearance of the headset can be dynamically altered by applying thermochromic paints to the surface of, or incorporating thermochromic pigments into an outer skin material of the headset. Such thermochromic materials change their colors when exposed to different temperatures, such as a body temperature of a headset wearer.

It will be appreciated that while described primarily in the context of a mobile (e.g., cellular) telephone, the various features and embodiments of the present invention may be practiced with and/or incorporated into any number of different platforms, mobile or otherwise, including without limitation PDAs, laptop computers, handheld computers, organizers, “car kits”, etc.

Furthermore, the wireless interface between these devices and an external entity (such as, e.g., a local base station, WiFi node, IrDA node, etc) may comprise any number of different configurations, including without limitation cellular links (e.g., CDMA, WCDMA, GSM, TDMA, iDEN, UMTS, AMPS, etc.), local/personal area wireless (such as IEEE-Std. 802.11, 802.15, Bluetooth, etc.), WiMAX links, optical links, infrared links (e.g., IrDA), and even millimeter wave or satellite links.

Similarly, the wireless interface between the device and its removable component(s) may comprise RF links (such as the aforementioned Bluetooth, 802.11, 802.15 PAN, traditional ISM band FHSS or DSSS systems, FDMA or TDMA systems, etc.), infrared links, or other types of air interfaces. Hence, the invention may be practiced substantially independent of any particular configuration of wireless interface.

It is noted that many variations of the methods described above may be utilized consistent with the present invention. Specifically, certain steps are optional and may be performed or deleted as desired. Similarly, other steps (such as additional data sampling, processing, filtration, calibration, or mathematical analysis for example) may be added to the foregoing embodiments. Additionally, the order of performance of certain steps may be permuted, or performed in parallel (or series) if desired. Hence, the foregoing embodiments are merely illustrative of the broader methods of the invention disclosed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

1. A radio frequency communications device, comprising:
a first wireless interface adapted to transmit and receive radio frequency signals to a remote entity;
a body element having at least one recess formed therein;
a power source disposed substantially within said body element;
a detachable headset element adapted to be received at least partly within said recess;
a second wireless interface adapted to transfer communication signals between said body element and said headset;
a contactless interface between said body element and said headset, said contactless interface adapted to transfer communication signals between said body element and said headset when said headset is substantially received within said recess;
wherein when said headset element is received within said at least one recess, said headset element substantially assumes a first shape, and when said headset element is removed from said recess, assumes a second, predetermined shape.

2. The device of claim 1, further comprising a second contactless interface adapted to transfer power from said power source to said headset when said headset is substantially received within said recess.

3. The device of claim 1, wherein said contactiess interface is selected from a group consisting of:
a) communications means based on electromagnetic fields,
b) communications means based on radio frequency, and
c) communications means based on optical radiation.

4. The device of claim 1, wherein said contactless interface is configured to selectively activate or deactivate said second wireless interface.

5. The device of claim 2, wherein said first and second contactless interfaces are substantially integrated into a single interface.

6. The device of claim 1, wherein said second wireless interface is configured to selectively activate or deactivate said contactless interface.

7. The device of claim 1, wherein said headset comprises a substantially resilient material, said material allowing said headset to deform from a static configuration to assume said first shape.

8. The device of claim 1, wherein said first wireless interface comprises a cellular mobile interface selected from the group consisting of
a) CDMA,
b) GSM,
c) TDMA, and
d) UMTS;
and wherein said second wireless interface is selected from the group consisting of
a) Bluetooth,
b) IEEE Std. 802.11,
c) IEEE Std. 802.15,
d) amplitude modulation (AM)
e) frequency modulation (FM),
f) phase modulation (PM),
g) pulse width modulation (PWM),
h) pulse position modulation (PPM), and
i) infrared.

9. Communications apparatus for use with a wireless communication device, comprising:
a communications element adapted for removable storage within said wireless communication device, said element being configured for contactless communication with said wireless communication device;
wherein said communications element is further adapted to substantially assume a predetermined shape upon removal from said wireless communication device.

10. The apparatus of claim 9, wherein said communications element comprises a headset.

11. The apparatus of claim 9, wherein said predetermined shape is different than that of a shape assumed by said element when said element is received within said communication device.

12. The apparatus of claim 9, wherein said contactless communication with communication device occurs only when said element is received substantially within said device.

13. The apparatus of claim 9, wherein said communications element further comprises a wireless transceiver, said wireless transceiver being adapted to communicate with a corresponding wireless transceiver of said wireless device.

14. The apparatus of claim 12, wherein said contactless communication comprises transferring data signals across a contactless interface between said communications element and said wireless device.

15. The apparatus of claim 12, wherein said contactless communication comprises transferring power across a contactless interface between said communications element and said wireless device.

16. The apparatus of claim 12, wherein said contactless communication comprises transferring power and data signals across a contactless interface between said communications element and said wireless device.

17. The apparatus of claim 14, wherein said contactless interface between said communications element and said wireless device is selected from a group consisting of:
a. communications means based on electromagnetic fields,
b. communications means based on radio frequency, and
c. communications means based on optical radiation.

19. A method of operating a headset being disposed substantially within a communications device, said disposed headset having a first shape, comprising:
removing said headset from within said device, said act of removing causing said headset to assume a second shape;
disposing said headset onto at least a portion of a user's head; and
wirelessly communicating with said device via said headset.

20. The method of claim 19, further comprising replacing said headset substantially within said device, said act of replacing causing said headset to assume said first shape.

21. The method of claim 19, wherein said act of removing causes activation of a wireless link between said headset and said device, said wireless link allowing said act of wirelessly communicating.

22. The method of claim 19, wherein said act of disposing induces said headset to change color.

23. The method of claim 19, further comprising establishing a wireless link between said device and an external entity, said wireless communication with said device via said headphone and said wireless link between said device and said external entity forming a communication channel between said user and said external entity.

24. A wireless communications system comprising a detachable headset and an electronic device, said headset removably stored on said device, said headset adapted for communication with said device in at least one of two modes:
a first mode such that when stored on said device, said headset communicates with said device via a contactiess communications interface; and
a second mode such that when removed from said device, said headset communicates with said device via a wireless communications interface.

25. The system of claim 24, wherein said contactless interface is adapted for short range operation between said headset and said device, and is selected from a group consisting of:
a. communications means based on electromagnetic fields, and
b. communications means based on optical signals.

26. The system of claim 24, wherein said wireless interface is selected from a group consisting of:
a. Bluetooth,
b. IEEE Std. 802.11,
c. IEEE Std. 802.15,
d. Amplitude modulation (AM),
e. frequency modulation (FM),
f. phase modulation (PM),
g. pulse width modulation (PWM),
h. pulse position modulation (PPM), and
i. infrared.
